(19) United States
(12) Patent Application Publication
(10) Pub. No.: US 2014/0224062 A1
(43) Pub. Date: Aug. 14, 2014

(54) BICYCLE PEDAL SYSTEM

(71) Applicant: VP CONCEPTS LLC, Hollywood, FL (US)

(72) Inventors: LEONARD VIGLIOTTI, HOLLYWOOD, FL (US); PAUL BERKEMEIER, GRAND RAPIDS, MI (US)

(73) Assignee: VP CONCEPTS LLC, Hollywood, FL (US)

(21) Appl. No.: 14/177,835

(22) Filed: Feb. 11, 2014

Related U.S. Application Data
(60) Provisional application No. 61/763,213, filed on Feb. 11, 2013.

(51) Int. Cl. B62M 3/08

(52) U.S. Cl. CPC B62M 3/086
USPC 74/594.6

(57) ABSTRACT

A pedal assembly includes a frame assembly that has a platform defined by platform halves pivotable relative to one another. The frame assembly includes an actuator, a sensor and a controller. A locking linkage is operatively connected to the actuator to hold the platform halves in a substantially planar position. A cleat engages the platform in the substantially planar position. The controller is configured to control the actuator and release the locking mechanism based upon a release condition being met.

### CROSS-REFERENCE TO RELATED APPLICATION

This application claims the priority, under 35 U.S.C. §119(e), of provisional application No. 61/763,213, filed Feb. 11, 2013; the prior application is herewith incorporated by reference in its entirety.

### BACKGROUND AND RELATED ART

The present invention pertains to a bicycle pedal assembly that is used to drive the crank of the bicycle. The present invention is an improvement over existing clipless pedals.

Clipless pedals are used to securely attach a cyclist's foot to the pedal to maximize power transfer from the cyclist to the crank and the drive system of the bicycle. Clipless pedals operate together with a cleat that is affixed to the bottom of a cycling shoe. Typically, the cleat engages the pedal and overcomes a spring loaded latching device to clip in and secure the cleat to the pedal. The release of the cleat from the pedal is commonly achieved by twisting the heal of the foot away from the bicycle. The spring of the spring loaded latching device is typically very strong and is there for difficult to overcome by the unnatural motion of twisting the heal away from the bicycle.

The disadvantages of existing clipless pedals are that when stopping the bicycle, the twisting motion to release the clip/shoe from the pedal is cumbersome and difficult, especially for novice cyclists. Moreover, the engaging of the cleat to the pedal can be difficult since the toe of the cleat has to be properly positioned and the spring force to overcome is relatively strong. Furthermore, since clipping in is generally done at slow speed, the stability/balance of the bicycle is not optimal. Therefore, if a cyclist clips in and simultaneously loses balance or is coming to a stop from travelling at speed, the difficulty in unclipping from the pedal may not allow the cyclist to release from the pedal to place a foot onto the ground in time to avoid a fall. Furthermore, due to the above, many cyclists are intimidated by clipless pedals and therefore avoid installing clipless pedals, which in turn does not allow the cyclist to obtain the power transfer benefits afforded by clipless pedals.

### SUMMARY OF THE INVENTION

It is accordingly an object of the invention to provide a pedal assembly, which overcome the hereinafore-mentioned disadvantages of the heretofore-known devices of this general type.

With the foregoing and other objects in view there is provided, in accordance with the invention, a pedal assembly includes a frame assembly that has a platform defined by platform halves pivotable relative to one another. The frame assembly includes an actuator, a sensor and a controller. A locking linkage is operatively connected to the actuator to hold the platform halves in a substantially planar position. A cleat engages the platform in the substantially planar position. The controller is configured to control the actuator and release the locking mechanism based upon a release condition being met.

Other features which are considered as characteristic for the invention are set forth in the appended claims, noting that any combination of the invention described above and of the further developments of the invention described above also represents an advantageous further development of the invention. Further advantages and embodiments of the invention that are advantageous in structural and functional terms become apparent from the dependent claims and from the description of exemplary embodiments with reference to the appended figures.

Although the invention is illustrated and described herein as embodied in a die-cutting machine and a method for adjusting a pressing force in a die-cutting machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The embodiments of the invention are illustrated by way of example, and not by way of limitation, in the figures of the accompanying drawings in which like reference numerals refer to similar elements. In the drawings:

FIG. 1 is top plan view of the bicycle pedal assembly with the cleat according to the invention;

FIG. 1A is a perspective view of the bicycle pedal;

FIG. 1B is another perspective view of the bicycle pedal according to the invention showing internal components of the pedal;

FIG. 1C is an enlarged perspective view of the internal components of the pedal of the bicycle pedal according to the invention showing;

FIGS. 1D-1G are different side views of the bicycle pedal according to the invention;

FIGS. 2A-2C are perspective views of the bicycle pedal according to the invention showing the progression of movement of the pedal during a releasing function of the pedal;

FIGS. 3A-3C are side views of the bicycle pedal according to the invention showing the progression of movement of the pedal during a releasing function of the pedal; and

FIG. 4 is a block diagram of the microchip logic showing control of the bicycle pedal according to the invention showing.

### DETAILED DESCRIPTION

In the following description, numerous specific details are set forth. However, it is understood that embodiments of the invention may be practiced without these specific details. In other instances, well-known structures and techniques have not been shown in detail in order not to obscure the understanding of this description.

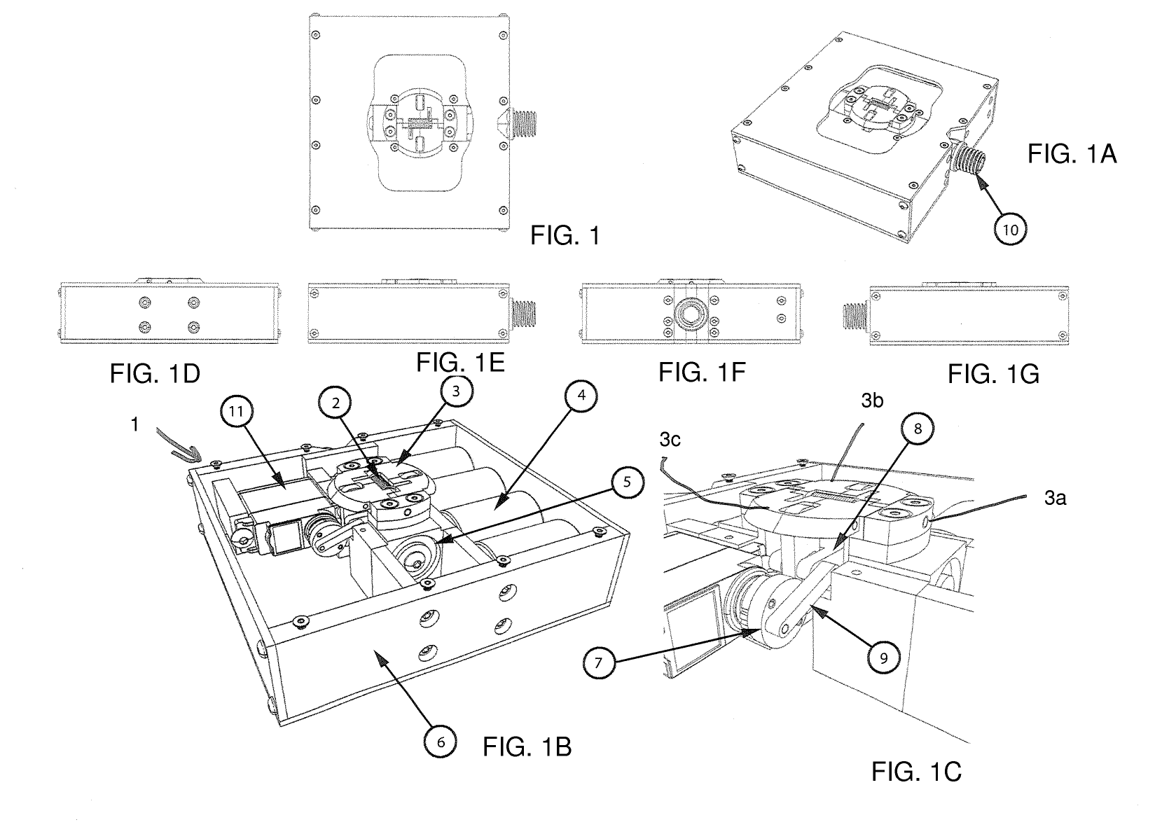

FIGS. 1 show a pedal assembly 1, which includes a pedal body or frame 6 and a cleat 30 (shown in FIG. 3A). The cleat 30 has mounting holes or slotted holes 31 which are disposed to correspond to the standard for threaded mounting hole locations provided in standard cycling shoes. Alternatively, it is possible for mounting holes 31 to be disposed to accommodate a hole pattern in shoes that are unique to the cleat 30. The cleat 30 includes a locking clip 32 which may be provided as a c-spring/circlip which is retained in a cavity (not shown) of the cleat 30. The clip 32 is pushed down over a platform 3 of the pedal assembly 1 and a side of the clip 32 securely holds the cleat 30 to the platform 3 when pulling away from the platform 3.

The pedal body 6 includes a threaded spindle 10, which is threaded to match a threaded hole on the crank of the bicycle. A battery 4 is disposed within the pedal body 6 for powering a servo motor 11 serving as an actuator, and a Hall effect magnetic sensor assembly 5 includes a magnetic sensor, a multi-pole magnet, and a controller (microchip), which controls the servo motor 11. The Hall effect magnetic sensor assembly 5 has the ability to detect rotational direction and polarity of the multi-pole magnet to determine rotation direction. Although the sensor is disclosed as a Hall effect magnetic sensor assembly 5, it is possible to implement other sensors which can determine rotation direction.

The platform 3 has a rotational axis 3a about which halves 3b, 3c of the platform 3 are able to pivot out of the substantially planar position shown in FIG. 1B. A torsion spring 2 disposed at the rotational axis 3a serves for biasing the platform 3 into the planar position.

The servo motor 11 drives a cam 7 coupled thereto. The cam 7 has a cam link 9 affixed to a locking linkage 8. The locking linkage 8 includes mounting arms 8a fastened to the platform 3 at each of the platform halves 3b, 3c by respective axes. The mounting arms 8a are operatively connected to one another by a linkage bar 8b which is operatively connected to the cam link 9.

The mounting arms 8a each have a substantially L-shaped control slot 8c which accommodates a locking pin/shaft 8d driven by the servo motor 11 via the cam 7 and the cam link 9. The control arms 8a may each be provided with a stabilizing slot 8e which accommodates a guide pin 8f which is fixed to the frame 6 and serves to further stabilize the mounting arms 8a during movement of the mounting arms 8a. It is possible to replace the servo motor 11 and cam 7 with a solenoid (not shown) serving as the actuator for controlling the movement of the linkage bar 8b and thus the locking pins 8d.

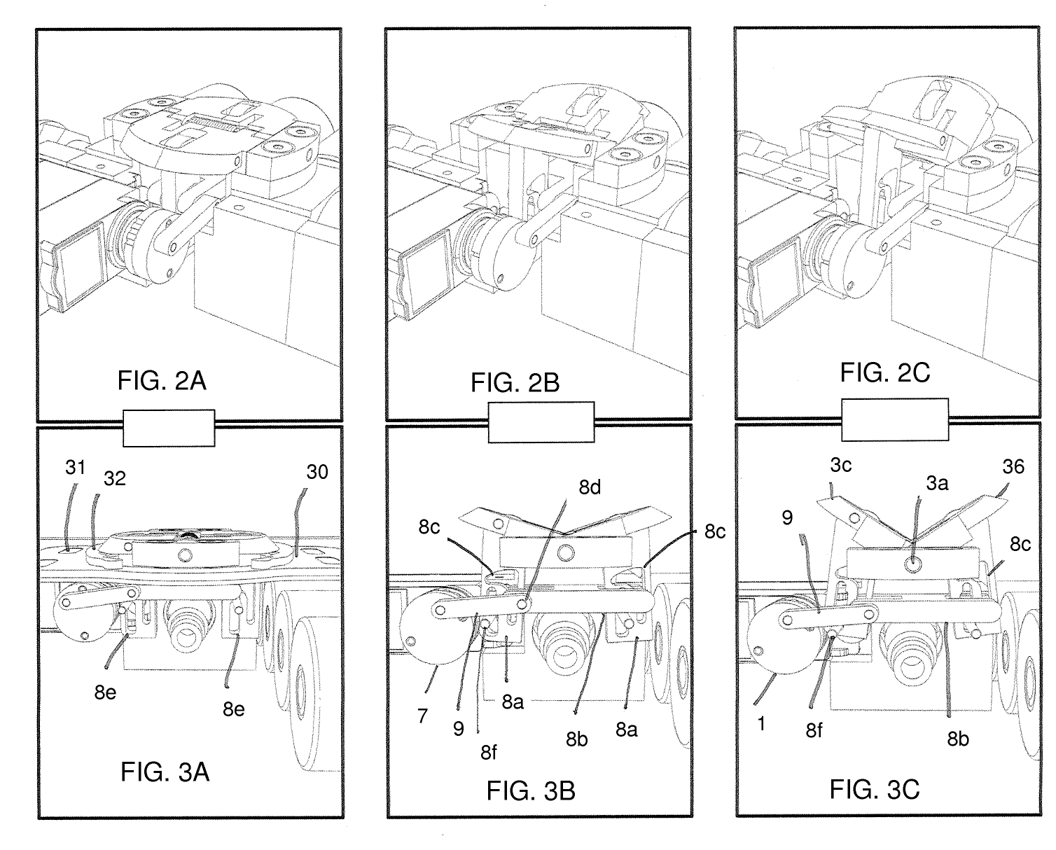

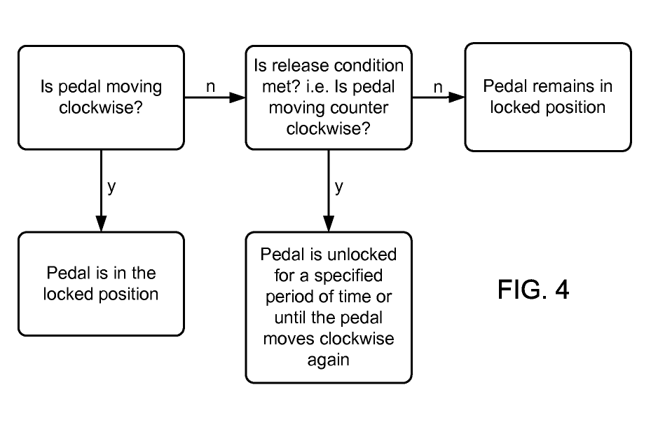

The operation of the pedal assembly is discussed below. As shown in FIG. 2A when no cleat is present, the spring 2 biases the platform halves 3b, 3c into the planar position. The locking pins 8d are positioned in the L-shaped slots 8c to prevent a folding motion of the platform halves 3b, 3c and the platform 3 is ready to accept the cleat 30 mounted to a riding shoe of a rider. The rider places the cleat 30 and applies pressure to the cleat 30. This results in a chamfered edge of the platform 3 deflecting the spring clip 32 and allows the spring clip 32 to expand sufficiently to pass the platform 3, at which point the spring clip 32 returns to an unbiased state in which the clip 32 is retained by a backside of the platform 3. As shown in the figures, the backside edge of the platform 3 does not have a chamfer and therefore the spring clip 32 cannot be disengaged by pulling away from the platform in a manner such as is encountered during a pedal stroke by the rider. Accordingly, the rider is locked in and the rider can utilize the benefits of a clipless pedal.

The magnetic sensor assembly 5 detects crank rotation and rotation direction. The magnetic sensor assembly 5 is programmed to recognize a predefined release condition based upon crank rotation, such as a backpedaling (direction), a stop in pedal stroke over a given time, or some other condition pertaining to the pedal stroke. Upon recognition of the release condition, the controller signals the servo motor 11 to drive the cam 7 thus displacing the cam link 9, which results in a movement of the locking pins 8d in the L-shaped slots 8c. The movement of the locking pins 8d results in that the force of the torsion spring 2 is all that must be overcome to pivot the platform halves 3b, 3c, which now allows the platform halves 3b, 3c to pivot towards one another when the rider pulls away from the platform 3 with sufficient force to overcome the torsion spring 2. The force of the spring 2 being minimal such that a removal from the platform is not unnecessarily hindered. The progression of the pivot motion of the platform halves 3b, 3c is shown in FIGS. 2B, 2C, 3B, and 3C. Once the cleat 30 is clear of the platform halves 3b, 3c, the torsion spring 2 biases the platform halves 3b, 3c back into the planar position and the servo motor is instructed to move the locking pins 8d back into the locked position of the L-shaped slots 8c as shown in FIG. 3A. In event that the rider meets the release condition but then does not disengage from the platform 3 over a preset time (such as if the danger passes without requiring the rider to disengage), the controller may be programmed to actuate the servo motor 11 to move the locking pins 8d back into the locked position within the L-shaped slots 8c. As such, it is not required to remove the cleat 30 from the platform 3 to relock the platform 3.

The present invention provides the ability to have a release mechanism which is entirely contained within the pedal assembly and does not require any ancillary components to operate. This in turn makes the pedal assembly 1 capable of conveniently replacing any existing pedal by merely threading the pedal assembly to the bicycle crank by the spindle 10. Also, the pedal assembly allows for release in the traditional manner of twisting the heal, so that the pedal assembly may be provided as a transition or training pedal when a rider desires converting to a clipless pedal system.

What is claimed is:

1. A pedal assembly comprising:
a frame assembly having a platform defined by platform halves pivotable relative to one another, said frame assembly including an actuator, a sensor, and a controller;
a locking linkage operatively connected to said actuator for holding said platform halves in a substantially planar position;
a cleat for engaging said platform in said substantially planar position;
said controller being configured for controlling said actuator and releasing said locking mechanism based upon a release condition being met.

2. The pedal assembly according to claim 1, wherein said release condition is based upon a crank rotation of a crank.
